(19) United States
(12) Patent Application Publication
(10) Pub. No.: US 2025/0232767 A1
(43) Pub. Date: Jul. 17, 2025

(54) SYSTEM AND METHOD FOR ENHANCED HUMAN-COMPUTER INTERACTION USING NATURAL LANGUAGE PROCESSING

(71) Applicant: Noa Kamehana'okala Thomas, Monmouth, OR (US)

(72) Inventor: Noa Kamehana'okala Thomas, Monmouth, OR (US)

(21) Appl. No.: 19/016,597

(22) Filed: Jan. 10, 2025

Related U.S. Application Data
(60) Provisional application No. 63/655,956, filed on Jun. 4, 2024.
(60) Provisional application No. 63/619,997, filed on Jan. 11, 2024.

(51) Int. Cl. G10L 15/22; G10L 15/18; G10L 15/183; G10L 15/30; H04M 1/72403

(52) U.S. Cl. CPC G10L 15/22; G10L 15/1815; G10L 15/183; G10L 15/30; H04M 1/72403; G10L 2015/223; H04M 2201/39

(57) ABSTRACT

A system and method for parameter-based control through natural language processing enables control of parameter-based systems using natural language commands. A server component processes commands through sequential modules including validation, sanitization, parameter processing, relative adjustment, semantic linking, and language processing capabilities. The server optimizes processing efficiency by handling commands at the lowest possible module and stopping once fulfilled. A user interface component captures voice or text commands and displays real-time parameter adjustments through visualization interfaces. A semantic linker network maps descriptive language to parameter values through interconnected nodes containing parameter settings and associated descriptive terms. The system implements fallback processing through external language models when simpler processing methods are insufficient. A database component maintains persistent storage of system information including parameter values, usage patterns, and user preferences.

### CROSS-REFERENCE TO RELATED APPLICATIONS

This application claims the benefit of U.S. Provisional Application No. 63/655,956, filed on Jun. 4, 2024, and U.S. Provisional Application No. 63/619,997, filed on Jan. 11, 2024. The entire disclosures of the above applications are incorporated herein by reference.

### FIELD

The present technology relates to systems and methods for enhancing human-computer interaction through natural language processing and computer vision, and, more particularly, to the integration of these technologies to facilitate efficient user interfaces across various applications.

### INTRODUCTION

This section provides background information related to the present disclosure which is not necessarily prior art.

In the field of human-computer interaction, a graphical user interface (GUI) can rely on various physical manipulations to provide input, such as clicking, typing, and dragging. These methods can present a learning curve and can be cumbersome for users who are not well-versed in computer operations. Reliance on manual input manipulations can limit the speed and intuitiveness of a user's interaction with a digital system.

Interaction with computer systems can accordingly require extensive use of mouse and keyboard inputs, which can be inefficient and time-consuming. Adjusting parameters through GUIs often involves multiple steps for each adjustment and can interrupt the creative flow of the user. For example, a digital audio workstation (DAW) allows users to record, edit, and/or mix master audio tracks with high precision and flexibility. However, the complexity of a DAW interface can present a significant barrier to the user, particularly one who is new to audio production or does not have technical training in sound engineering. The user may have to navigate through complex menus and learn numerous functions and keyboard shortcuts to use the system. This type of interaction does not align with the dynamic and spontaneous nature of the creative process for certain users.

It can be difficult to provide a system with a GUI that addresses various accessibility issues. Individuals with physical disabilities may find input devices like keyboards and mice challenging to use. The need for physical interaction with devices can also be a barrier in situations where hands-free operation is preferred or necessary. Additionally, certain systems do not allow for seamless interaction between a mobile device and a primary computing environment of a user, limiting the ability to perform tasks remotely. Natural language processing and computer vision technologies offer potential for enhancing human-computer interaction. While attempts have been made to integrate these technologies, there continues to be shortcomings in the sophistication and system design needed to handle complex commands or understand contextual nuances, leading to errors and user frustration.

There is a continuing need for more intuitive and accessible human-computer interaction systems and methods. Desirably, such systems and methods would overcome the limitations of GUI-based interactions by incorporating advanced natural language processing and computer vision technologies to provide a natural, efficient, and user-friendly way to control and interact with computers and other digital devices, while enhancing both individual creativity and collaborative efforts.

### SUMMARY

In concordance with the instant disclosure, more intuitive and accessible human-computer interaction systems and methods, has surprisingly been discovered.

The present technology includes articles of manufacture, systems, and processes that relate to the integration of natural language processing and computer vision to facilitate intuitive and efficient human-computer interactions across various applications including digital audio production and control, while leveraging advanced processing protocols for command interpretation and execution.

In certain embodiments, a system for parameter-based control through natural language processing can include a user interface component and a server component that can be configured to receive a natural language command from the user interface component. The server component can process the natural language command through processing modules that can include validation, sanitization, parameter processing, relative adjustment, semantic linker and language processing modules. The server component can generate a parameter adjustment command when the natural language command processing is fulfilled by one of the modules.

In certain embodiments, a method for parameter-based control through natural language processing can include receiving a natural language command at a server component, and processing the sanitized command through validation, sanitization, parameter processing, relative adjustment, semantic linker and language processing modules. The method can include stopping the processing when the command can be fulfilled at any module, generating parameter adjustment commands based on the processed command, and storing system information in a database component.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a system diagram illustrating a system for parameter-based control through natural language processing.

FIG. 2 is a method flowchart illustrating steps for parameter-based control through natural language processing.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology improves the efficiency and intuitiveness of human-computer interactions by leveraging advanced natural language processing as described in greater detail herein. The present technology allows users to interact with computing devices in a more natural and accessible manner, reducing the cognitive load and physical constraints associated with traditional graphical user interfaces. Through the integration of sophisticated processing protocols and semantic linking networks, the present technology enhances the accuracy and speed of command interpretation while minimizing computational overhead. For example, in the context of digital audio production, the present technology improves workflow efficiency by enabling intuitive control of audio parameters through natural language commands, facilitating real-time collaboration, and providing seamless integration between mobile devices and primary computing environments. The present technology further improves accessibility by reducing reliance on physical input devices and enabling hands-free operation where preferred or necessary.

A comprehensive system for enhancing parameter-based system control through natural language processing is provided. The system can enable control of parameter-based systems through natural language commands, with a particular server architecture for command processing. The system can enable natural language control of various parameter-based systems, such as digital audio workstations as a non-limiting example, where control can include adjusting various parameters such as audio effects, volume levels, frequency bands, and/or compression settings. The system can also control display systems where parameters can adjust brightness levels, color settings, and contrast ratios. It should be appreciated that the system can process natural language commands to control any device or software that has configurable parameters, translating user instructions into specific parameter adjustments through the processing steps described in greater detail herein.

A user interface component can capture voice commands through a mobile application or desktop plugin. The user interface component can convert spoken instructions into text format that can be processed by the system. A server component can receive the text commands and process them through successive steps described in greater detail herein, working from basic validation through to complex language model processing as needed. The server component can then send specific parameter adjustment commands back to the user interface component, which can execute these changes on the parameter-based system. The adjustments can be displayed in real-time through parameter visualization interfaces, allowing users to see the immediate effects of the commands. A database component can maintain persistent storage of system information, including parameter values, usage patterns, command history, processing outcomes, and user preferences. The stored information can be accessed by the server component during future command processing to improve the accuracy and efficiency of parameter adjustments. Advantageously, through this integrated approach, users can control complex parameter-based systems using natural language commands, with the system handling the translation from spoken or written instructions to specific parameter adjustments.

The user interface component can be configured to receive natural language instructions through various implementations. The user interface component can serve as the primary point of interaction between users and parameter-based systems through command input and execution interfaces. The conversion of spoken instructions to text can be performed by a speech to text module within the user interface component. The user interface component can include command input interfaces for receiving natural language instructions, response display capabilities for showing command outcomes, and parameter visualization interfaces for monitoring system states in real-time. The command input interface can process various types of natural language commands including direct parameter value commands, relative adjustment commands, and descriptive commands. The user interface component can provide visual feedback through parameter visualization interfaces, display real-time parameter states and adjustments, enable parameter control through interfaces, and manage multiple system instances. The user interface component can maintain communication with the server component to enable command processing and parameter adjustments.

When implemented as a mobile application, the user interface component can capture voice commands through a device microphone and convert spoken language to text format. The mobile implementation can include a button interface that changes state during voice capture, providing visual feedback through background color changes. For example, the button interface can include a button that changes from “Press . . . ” to “Listening . . . ” with a corresponding background color shift from red to green during voice capture. The mobile implementation can convert the captured voice commands to text format for processing.

The mobile application of the user interface component can additionally support augmented reality (AR) visualization features for enhanced parameter control and monitoring, for example, through an AR interface. The AR interface can display the full set of parameters in an easily accessible AR environment, aligning parameter controls horizontally with instance names displayed to the left. The AR interface can show changes in parameters in real-time as they are adjusted, with selected modules highlighted in orange while others remain red. The AR interface implementation can provide intuitive visual organization of multiple instances stacked vertically in the AR space.

When implemented as a desktop plugin, the user interface component can integrate directly with parameter-based systems through dedicated plugin architectures. The desktop implementation can provide text-based command input interfaces, third party plugin display capabilities, and comprehensive parameter state visualization features. The plugin implementation can enable direct system integration while maintaining all core interface functionalities. The desktop plugin of the user interface component can also include the speech to text module and receive audio commands via a microphone of the desktop. Alternatively, the desktop plug in can also receive direct text inputs from the user.

The user interface component can also be implemented as a general interface that integrates into existing systems. The general interface implementation of the user interface component can process both text and voice inputs while providing visualization capabilities and system feedback through appropriate display interfaces. Regardless of implementation, the user interface component can display real-time parameter states and adjustments through parameter visualization interfaces. The component can provide visual feedback through response displays, enable parameter control through intuitive interfaces, and manage multiple system instances when required. The user interface component can accept various types of natural language commands including direct parameter value commands, relative adjustment commands, and descriptive commands. For each command type, the user interface component can provide immediate visual feedback through parameter visualization displays and real-time adjustment confirmation. The user interface component can maintain communication with the server component to enable command processing and parameter adjustments. The user interface component can receive processed commands from the server and execute corresponding parameter changes while providing visual feedback through appropriate display interfaces.

In certain embodiments, the user interface component can enable synchronized communication between mobile and desktop implementations through server-based coordination. The mobile application and desktop plugin can maintain consistent parameter states by sending updates to the server component, which can process these updates and maintain synchronization across both the desktop plug in and mobile application embodiments of the user interface component. When a user adjusts parameters through either the mobile application or desktop plugin, the user interface component can send current parameter values to the server component. The server component can update the database with these values and return the latest parameter states to both implementations, enabling real-time synchronization of parameter visualization displays and control interfaces. The system can support collaborative interaction through community features that enable multiple users to access and control parameters through the user interface component. Users can join sessions through quick-response (QR) code authentication, enabling synchronized parameter control and visualization across both the mobile application and the desktop plug in of the user interface component. The system can maintain consistent parameter states and provide real-time updates to all connected interfaces.

The server component can implement processing functionality through multiple integrated modules to enable natural language parameter control. The server component can receive text natural language commands from user interface component and process the text commands through sequential processing modules, which are described in greater detail herein. The server component can process commands through the modules sequentially, working from basic validation through increasingly sophisticated processing capabilities. The server component can optimize processing efficiency by handling commands at the lowest possible module and stopping once the command is fulfilled. For example, simple parameter-value commands like “set brightness to 50” can be handled at a low-level module without requiring more complex processing. However, high-level commands using descriptive language like “a beautiful subtle reverb” can require processing through higher level modules to interpret the descriptive terms and determine appropriate parameter values. The layered approach can reduce computationally expensive processing by minimizing the number of commands that require complex language model processing.

A validation module can process the text command received by the server component. The validation module can implement multiple validation constraints to ensure command quality and militate against invalid commands from reaching higher processing layers. The validation constraints can include a predetermined set of constraints determined based on the particular parameter-based system. The validation module can check command length to ensure proper formatting, detect and filter profanity from user inputs, identify blank or empty commands that require no processing, validate long inputs that may exceed system constraints, and examine character composition to identify consonant-only or vowel-only inputs that may indicate malformed commands. When receiving commands from the user interface component, the validation module can apply the validation rules to incoming commands, generate appropriate error messages when validation issues are detected, stop further processing of invalid commands, and route properly validated commands to subsequent processing layers.

A sanitization module can receive the validated command from the validation module and implement multiple techniques to reduce the size of the solution space for command processing. The sanitization module can process the validated commands by removing special characters including exclamation marks, “@” symbols, pound signs, dollar signs, percentage symbols, and other non-essential characters that could complicate command interpretation. The sanitization module can eliminate unnecessary words from commands to streamline processing. The unnecessary words can be a predetermined set of words and characters. For example, the sanitization module can remove common filler words such as “um,” “like,” “the,” and other terms that do not contribute to command meaning. In this way, word filtering can help reduce command complexity while maintaining essential command components. The sanitization module can implement a lemmatization process. The lemmatization process can reduce words to their root forms, enabling more effective matching in higher processing layers. By converting words to root forms, the sanitization module can increase the likelihood of successful matching in subsequent modules.

A cache module can implement comprehensive storage capabilities for all user inputs received by the system. The cache module can store commands that pass through from the validation module and sanitization module, maintaining records to support advanced analytics and model training capabilities. The cache module can maintain records of all user interactions to enable pattern analysis and system optimization. When a command is processed, the cache module can store the original command, an associated processing outcome, and an associated parameter adjustment to build a comprehensive history of system usage. The cache module can support higher processing layers by maintaining readily accessible command history. The cached information can be utilized to check incoming commands against previously processed and cached commands to enable rapid processing without requiring higher-layer operations.

A parameter processing module can process direct parameter-value commands through programmatic handling capabilities. The parameter processing module can handle commands in specific formats that directly specify parameter values, supporting both single parameter-value pairs and multi-parameter configurations. The parameter processing module can process commands where parameters can be identified through direct matches, fuzzy matches, or aliases to named parameters. During command processing, parameter processing module can generate descriptions programmatically in a standardized format of “{parameter} set to {value}”. When the layer detects a valid parameter-value command format, the parameter processing module can return the specified values along with a static message confirming “Parameter [name] set to [value].” When processing commands, the parameter processing module can handle various formats including multiple parameters provided in a sequence (e.g., “parameter 1, value 1, parameter 2, value 2”) and grouped parameter settings (e.g., “parameter 1, parameter 2, value 1, value 2”). Through systematic parameter-value command processing, the parameter processing module can provide efficient handling of direct parameter adjustment commands while maintaining clear feedback through standardized response messaging.

A relative adjustment module can identify and process commands that request relative parameter adjustments through modifier-based scaling capabilities. The relative adjustment module can process commands in the format of {increase/decrease} {modifier?} {parameter}, where the modifier term can be optional. When processing commands, the relative adjustment module can set a baseline modification amount for standard increase or decrease instructions. The relative adjustment module can implement modifier scaling to adjust the magnitude of parameter changes. For example, the relative adjustment module can process a command like “make it brighter” by applying a standard 10% increase, while scaling the adjustment for modified commands like “make it way brighter” to apply a larger 25% increase. The scaling capability can enable proportional parameter adjustments based on the command modifier. During command processing, the relative adjustment module can handle both single and multi-parameter addressing for increase and decrease commands. The layer can generate descriptions programmatically in a standardized format of “{parameter} has increased by {x} to {y}”. When the relative adjustment module detects a valid increase/decrease command format, the relative adjustment module can return the adjusted values along with a static message confirming the parameter changes.

A semantic linker module can map descriptive language to parameter values through a semantic linker network (SLN) that maintains structured relationships between natural language descriptions and specific parameter settings. The SLN can include interconnected command nodes, where each node can contain defined parameter values along with comprehensive collections of associated descriptive words and their synonyms. The SLN can process natural language through multiple layers of semantic understanding. For example, when processing a command for an audio reverb effect, a command node can map descriptive words like “huge” to specific technical parameters such as length and width values, while simultaneously maintaining semantic connections to related descriptive terms like “massive,” “insane,” “enormous,” “big,” and “large.” The network of associations can enable natural language processing across a broad spectrum of descriptive terminology.

The semantic linker module can implement a two-stage processing approach when handling descriptive commands through the SLN. First, the semantic linker module can extract descriptor words from the incoming command using a language model. Then, the server component can identify relevant parameter values associated with those descriptors by traversing the semantic network and locating matching nodes or synonyms. When multiple matches are found within the network, the semantic linker module can implement averaging algorithms to determine appropriate parameter values. For example, if a command contains descriptors that match multiple nodes in the network, the semantic linker module can calculate averaged parameter values across all matching nodes to determine the final parameter settings.

The semantic understanding of the SLN can be dynamically expanded over time through continuous learning. When processing new commands, the semantic linker module can make secondary application programming interface (API) calls or otherwise communicate to external language models to extract additional descriptor words, identify relevant parameter relationships, and generate new synonym associations. The new semantic relationships can be integrated into the SLN, enabling the ability to handle an increasingly diverse range of descriptive language. For each processed command, the semantic linker module can cache both the command and any resulting parameter adjustments within the SLN. The caching mechanism can enable rapid processing of similar future commands while continuously expanding the semantic understanding of the SLN. The cached results can be used to inform future parameter adjustments and improve processing accuracy over time. The semantic linker module can generate structured educational responses based on SLN processing. The responses can include detailed explanations of parameter adjustments, describing what parameters were modified, how they were adjusted, and the relationship between the descriptive language used and the technical parameters affected. The educational responses can be formatted to include specific parameter values, descriptive rationales, and guidance for future adjustments.

A command match module can implement efficient processing of repeated commands through cache matching capabilities. The command match module can look for matches to previously cached commands stored by the cache module. When a match to a cached command is found, the command match module can return the associated parameter values along with educational responses that explain the parameter adjustments. During command processing, the command match module can check incoming commands against the command cache to enable rapid processing without requiring higher-layer operations.

A language processing module can process complex commands through structured interaction with external language models when simpler processing layers cannot handle the command. The language processing module can pass commands to a language model or other text input model through API calls, structuring prompts that include context about available modules and user input. When the language model returns structured responses, the language processing module can process these into parameter adjustments while caching results for future use. If the language model processing fails to generate valid parameter adjustments, the language processing module can retry the processing attempt.

A failsafe module can implement comprehensive fallback handling when no other processing layer successfully handles the command. When commands reach the failsafe module, indicating that local processing layers and LLM processing have failed to generate valid parameter adjustments, the failsafe module can return a “Try again . . . ” message to the user. The failsafe module can serve as the final processing step, ensuring that users receive appropriate feedback even when commands cannot be successfully processed through other layers. The failsafe capability can maintain system stability while providing clear user feedback for unsuccessful command processing attempts.

The following examples illustrate how the server component can process different types of natural language commands through its layered approach, demonstrating the sequential processing capabilities from basic validation through complex language model integration.

Example 1—Direct Parameter Command: For a command like “set brightness to 50”, the server component can process the command at the parameter processing module. The command can pass through initial validation and sanitization, then be handled programmatically at the parameter processing module since it contains a direct parameter-value pair. The parameter processing module can return the value 50 for the brightness parameter along with a confirmation message “Parameter brightness set to 50”.

Example 2—Relative Adjustment Command: For a command like “make it way brighter”, the server component can process the command through the relative adjustment module. After validation and sanitization, the relative adjustment module can identify the command as an increase command with a modifier “way”. The server component can apply scaled modification, such as a 25% increase due to the “way” modifier, compared to a standard 10% increase for an unmodified “make it brighter” command.

Example 3—Descriptive Command: For a command like “create a huge reverb”, the server component can process the command through the semantic linker module. The SLN can contain a node mapping “huge” to specific reverb parameters (e.g., Length=90, Width=80) along with synonyms like “massive” and “enormous”. The semantic linker module can match the descriptor “huge” to the related node and apply the associated parameter values.

Example 4—Complex Command Requiring a Large Language Model (LLM): For a more complex command like “make it sound like it's underwater,” which may not match any cached commands or SLN nodes, the language processing module can be used to process the command. The language processing module can make an API call to a language model with a structured prompt containing the command and available parameters. The LLM can return appropriate parameter values, which the cache module can then cache for future use.

The database component can provide persistent storage and data management capabilities to support comprehensive system operations. The database can store historical data to support system optimization and user experience enhancement. The historical storage can include comprehensive usage patterns over time, detailed command processing history, parameter adjustment outcomes, and system state records. The historical data storage can enable pattern analysis and system improvement through detailed record maintenance. The database can maintain user-specific data including profile information and credentials, individual preferences and settings, personal usage patterns, and authentication data. The user data storage can enable personalized experiences while supporting secure multi-user access through session token management and authentication protocols. For session management, the database can store current active instances, unique instance identifiers, instance status information, and session authentication tokens. The database can implement automatic session management through date field tracking, where instances can be removed if inactive for more than 30 seconds, and date fields can be updated for active instances.

### APPLICATIONS

The following examples demonstrate various applications of the natural language parameter control capabilities of the system across different domains. Through these implementations, the system can enable intuitive parameter adjustment, collaborative control, and educational support across audio production, video editing, and lighting design scenarios.

### Application 1: Audio Production Implementation

A music producer can implement the system to control audio parameters through natural language commands while working with a digital audio workstation (DAW). The producer can install the desktop plugin to communicate directly with the DAW while using the mobile application to enable remote parameter control through voice commands. During a recording session, the producer can use voice commands through the mobile application like “add more reverb to the vocals” or “increase the bass.” The mobile application can capture these voice commands and convert them to text format, sending them to the server component for processing. The server component can process these commands through sequential layers, determining appropriate parameter adjustments and returning them to both the desktop plugin and mobile application embodiments of the user interface component. The producer can step away from the computer while maintaining control over audio parameters through the mobile application. Any adjustments made through either the mobile application or the desktop plugin can be synchronized in real-time through server component updates to the database. The system can enable continuous parameter control while providing educational feedback about parameter adjustments through Custom Educational Responses.

### Application 2: Video Production Implementation

Multiple video editors can collaborate on a project through synchronized parameter control of video effects and color grading across different locations. A primary editor can initiate a session and share access with collaborators through QR code authentication, enabling them to join the session through their mobile applications. The collaborators can view and adjust video parameters like brightness, contrast, and color balance through their respective user interface component, with all changes synchronized in real-time across connected devices. The system can maintain consistent parameter states through server coordination and database updates, enabling seamless collaboration regardless of physical location. During the collaborative session, editors can use the augmented reality interface to visualize parameter relationships and adjustments. The AR implementation can display parameters horizontally with instance names. The system can provide educational feedback to all users through Custom Educational Responses, helping team members understand parameter adjustments and their effects on the video output.

### Application 3: Lighting Control Implementation

A lighting designer can utilize the parameter control capabilities of the system to manage complex lighting installations. The designer can create a shared session where technicians can join through QR code authentication, enabling the designer to observe and adjust lighting parameters through their mobile applications. The system can provide control over multiple lighting parameters including intensity, color temperature, and movement patterns. When technicians make parameter adjustments, the system can generate educational responses explaining what changes were made, how they affect the lighting design, and guidance for fine-tuning settings. The system can enable remote control of lighting parameters while maintaining synchronized states across all connected devices. Through the augmented reality interface, technicians can visualize lighting parameter relationships and adjustments in an intuitive format. The system can maintain synchronized parameter states across all devices while providing real- time feedback about parameter adjustments. In this way, the implementation can enable precise lighting control while maintaining consistent parameter states and providing comprehensive feedback through educational responses.

### EXAMPLES

Example embodiments of the present technology are provided with reference to the figures enclosed herewith.

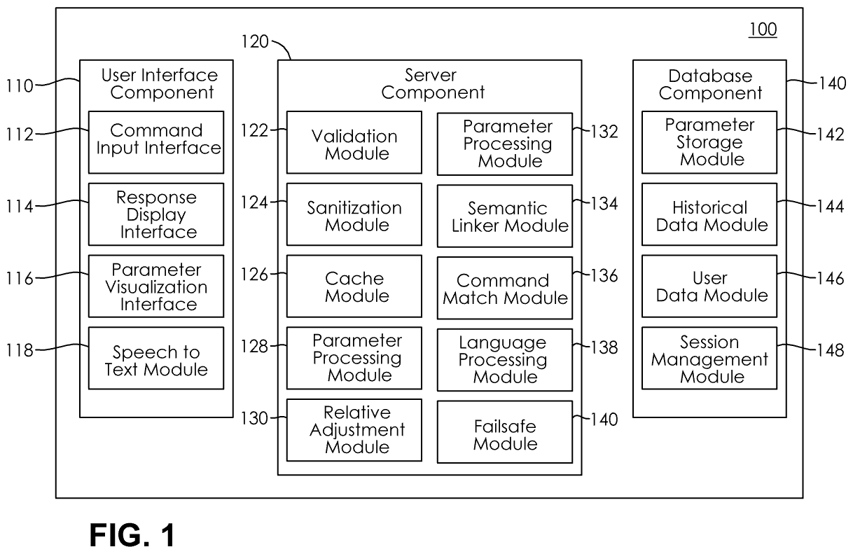

With reference to FIG. 1, a system 100 can include a user interface component 110, a server component 120, and a database component 140 working in concert to enable natural language parameter control. The user interface component 110 can include a command input interface 112 for receiving natural language commands, a response display interface 114 for showing command outcomes, a parameter visualization interface 116 for monitoring system states, and a speech to text module 118. The server component 120 can process commands received from the user interface component 110 through modules including: a validation module 122 for checking command integrity, a sanitization module 124 for cleaning commands, a cache module 126 for storing command data, a parameter processing module 128 for handling direct parameter commands, a relative adjustment module 130 for processing increase/decrease commands, a semantic linker module 132 for mapping descriptive language, a command match module 134 for checking cached commands, a language processing module 136 for external model integration, and a failsafe module 138 for fallback handling. The database component 140 can provide persistent storage through a parameter storage module 142 for maintaining parameter values, a historical data module 144 for tracking usage patterns, a user data module 146 for storing profile information, and a session management module 148 for handling multi-user access. The components can maintain synchronized communication paths enabling real-time parameter control and system monitoring.

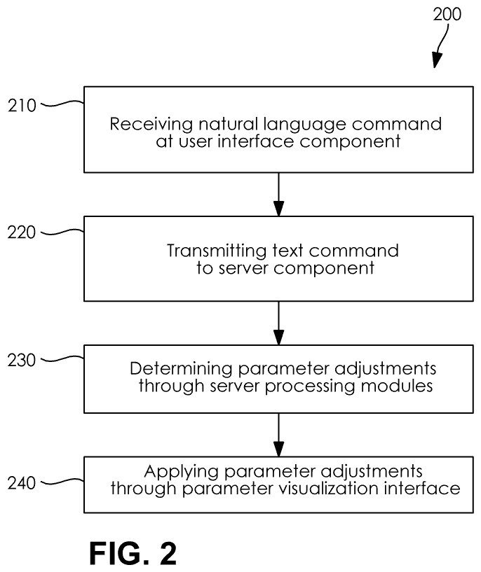

With reference to FIG. 2, a method 200 of using the system 100 can include a step 210 of receiving, at user interface component 110, a natural language command through command input interface 112. For voice commands, the user interface component 110 can convert the spoken instruction to text format through command input interface 112 and a speech to text module 118. A step 220 of transmitting the text command from user interface component 110 to server component 120 for processing. The server component 120 can then process the command through sequential processing modules described herein as needed, working from validation module 122 through to failsafe module 138. A step 230 of determining appropriate parameter adjustments through the server component processing modules of the server component 120. The server component 120 can optimize processing efficiency by handling commands at the lowest possible module and stopping once the command is fulfilled. A step 240 of applying the determined parameter adjustments through parameter visualization interface 116 of user interface component 110. The adjustments can be displayed in real-time through response display interface 114.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A system for parameter-based control through natural language processing, comprising:
a user interface component;
a server component configured to:
receive a natural language command from the user interface component;
process the natural language command through one or more processing modules until the natural language command is fulfilled, the processing modules including:
a validation module configured to validate command integrity;
a sanitization module configured to remove a predetermined set of unnecessary words and characters;
a parameter processing module configured to process a direct parameter-value command;
a relative adjustment module configured to process an increase/decrease command with a modifier;
a semantic linker module configured to map descriptive language to a parameter value through a semantic linker network; and
a language processing module configured to process a command that cannot be processed by the parameter processing module, the relative adjustment module, and the semantic linker module through external language models; and
generate a parameter adjustment command based on the processed natural language command.

2. The system of claim 1, wherein processing the natural language command through the one or more processing modules until the natural language command is fulfilled includes processing the modules sequentially through the validation module configured to validate the sanitization module, the parameter processing module configured to process a direct parameter-value command, the relative adjustment module, the semantic linker module, and the language processing module until the command is fulfilled.

3. The system of claim 1, further comprising a database component configured to maintain persistent storage of system information, the database component in communication with the server component.

4. The system of claim 1, wherein the user interface component includes a speech to text module.

5. The system of claim 3, wherein the mobile application includes a button interface that changes state during voice capture.

6. The system of claim 1, wherein the validation module is configured to perform a member selected from a group consisting of:
check command length to ensure proper formatting;
detect and filter profanity from user inputs;
identify blank or empty commands;
examine character composition to identify malformed commands; and
combinations thereof.

7. The system of claim 1, wherein the sanitization module is configured to remove a set of predetermined invalid characters.

8. The system of claim 1, wherein the sanitization module is configured to implement a lemmatization process to reduce words to their root forms.

9. The system of claim 1, wherein the semantic linker network includes:
interconnected command nodes containing defined parameter values;
collections of associated descriptive words and their synonyms; and
semantic connections to related descriptive terms.

10. The system of claim 8, wherein the semantic linker module is configured to extract descriptor words from the incoming commands using a language model and implement averaging algorithms when multiple matches are found.

11. The system of claim 1, wherein the processing modules further comprise:
a cache module configured to implement storage capabilities for user inputs;
a command match module configured to implement processing of repeated commands through cache matching; and
a failsafe module configured to implement fallback handling when no other processing layer successfully handles the command.

12. The system of claim 3, wherein the database component is configured to perform a member selected from a group consisting of:
store historical data including usage patterns, command processing history, and parameter adjustment outcomes;
maintain user-specific data including profile information and preferences;
implement automatic session management through date field tracking; and
combinations thereof.

13. A method for parameter-based control through natural language processing, comprising:
receiving, at a server component, a natural language command;
processing the sanitized command through one or more of the processing modules including:
a validation module configured to validate command integrity;
a sanitization module configured to remove a predetermined set of unnecessary words and characters;
a parameter processing module for a direct parameter-value command;
a relative adjustment module for an increase/decrease command;
a semantic linker module that maps descriptive language to parameter values; and
a language processing module for a command that cannot be processed by the parameter processing module, the relative adjustment module, and requiring external language model processing;
stopping the sequential processing when the natural language command is fulfilled at any module;
generating parameter adjustment commands based on the processed natural language command.

14. The method of claim 13, wherein validating the natural language command comprises:
checking command length to ensure proper formatting;
detecting and filtering profanity from user inputs;
identifying blank or empty commands; and
examining character composition to identify malformed commands.

15. The method of claim 13 wherein sanitizing the validated command further comprises implementing a lemmatization process to reduce words to their root forms.

16. The method of claim 13, wherein processing through the semantic linker module includes extracting descriptor words from the command using a language model and implementing averaging algorithms when multiple matches are found.

17. The method of claim 13, wherein processing through the language processing module comprises at least one of:
passing commands to an external language model through API calls;
processing structured responses into parameter adjustments; and
caching results for future use.

18. The method of claim 13, wherein storing system information comprises:
maintaining historical data including usage patterns and command processing history;
storing user-specific data including profile information and preferences; and
implementing automatic session management through date field tracking.

19. The method of claim 13, further including receiving the natural language command through a user interface component.

20. The method of claim 19, including converting spoken instructions into text format when the command is received as voice input.
